(19) United States
(12) Patent Application Publication
(10) Pub. No.: US 2006/0262362 A1
(43) Pub. Date: Nov. 23, 2006

(54) Image sensor drive control unit and image readout apparatus using the same

(75) Inventor: Dai Murakoshi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/400,523

(22) Filed: Apr. 10, 2006

(30) Foreign Application Priority Data
Apr. 8, 2005 (JP) 111965/2005

(51) Int. Cl. H04N 1/46

(52) U.S. Cl. 358/514; 348/241

(57) ABSTRACT

An image sensor drive control unit capable of preventing the degradation in image quality due to smearing or blooming with a minimum system change. The drive control unit includes a clock generator that outputs an effective pixel transfer clock during an effective pixel transfer period, and a dummy pixel transfer clock having a higher clock frequency than that of the effective pixel transfer clock during a dummy pixel transfer period following the effective pixel transfer period. The dummy pixel transfer period is set equal to a time period required for outputting a number of clocks corresponding to the number of dummy pixels when the clock frequency of the dummy pixel transfer clock is set equal to that of the effective pixel transfer clock.

### BACKGROUND OF THE INVENTION

1. Field of the Invention

The present invention relates to a drive control unit for driving an image sensor, such as CCD or the like, and an image readout apparatus for obtaining a radiation image from a storage phosphor sheet using the same.

2. Description of the Related Art

When radiation (X-ray, α-ray, β-ray, γ-ray, electron beam, ultraviolet ray, or the like) is irradiated on a certain type of phosphor, a part of the radiation energy is stored in the phosphor. It is known that such phosphor emits stimulated luminescence according to the energy stored therein when excitation light, such as visible light or the like, is irradiated thereon. The phosphor having such properties is called as storage phosphor. An Image readout system using the storage phosphor is proposed. In the system, radiation image information of a subject, such as a human body or the like, is tentatively stored on a storage phosphor sheet, and then excitation light is irradiated thereon to cause stimulated luminescence to be emitted therefrom, which is photoelectrically read out to obtain image signals.

A line sensor that uses an image sensor having a plurality of pixels, such as CCD or the like, is known as the sensor for detecting the stimulated luminescence. The line sensor may use a plurality of image sensors, as well as a single image sensor. When a plurality of image sensors is used, they are disposed such that a portion of each image sensor overlaps with a portion of the adjacent image sensor. A complete radiation image is obtained by aligning partial radiation images obtained by the respective image sensors as described, for example, in U.S. Patent Application Publication No. 20020028011.

In the method described in the aforementioned patent publication, a certain number of pixels are overlapped with each other at the boundary section of two image sensors, and the same position is read out by the two image sensors independently. Then, the output level of one of the image sensors in the overlapped region is adjusted to the other to implement real-time correction.

In the meantime, as the image sensor drive control method for outputting signal charges from the image sensor, such as CCD or the like, various methods are proposed as described, for example, in U.S. Pat. No. 7,009,740 and U.S. Patent Application Publication No. 20040160652. In the methods described in the aforementioned patent publications, the clock frequency during the dummy pixel transfer period is set higher than that during the effective pixel transfer period in order to reduce the time of each line period, thereby speeding up the readout time.

In the method described in U.S. Patent Application Publication No. 20020028011, partial images obtained by the respective image sensors may be aligned smoothly without any problem unless the signals of the overlapping foremost pixels are not affected by the signals of the latter pixels in the image sensor. But, if the foremost pixel signals are affected by the latter pixel signals due to, for example, blooming, poor total charge transfer efficiency, or the like, a strip-like transverse streak is developed due to difference in the level with the preceding line through level correction. Thus, the correction method proposed in the patent publication described above still requires a certain measure for preventing blooming.

The methods proposed in U.S. Pat. No. 7,009,740 and U.S. Patent Application Publication No. 20040160652 may be inadequate to prevent blooming satisfactorily. Further, they require modification in the duration of the line period, which inevitably accompanies changes in the timings of the signal processing means and image processing means for processing signal charges outputted from the image sensor. Thus, a major system change is required in order to implement these methods in the conventional apparatus.

It is an object of the present invention, therefore, to provide an image sensor drive control unit capable of preventing degradation in the image quality due to blooming with a minimum system change, and an image readout apparatus using such drive control unit.

### SUMMARY OF THE INVENTION

The image sensor drive control unit of the present invention is a drive control unit for driving an image sensor having a plurality of effective pixels and a plurality of dummy pixels disposed linearly to cause a signal charge stored in each of the effective pixels to be shift transferred from a CCD, wherein:

the drive control unit includes a clock generator that outputs:
an effective pixel transfer clock to the CCD during an effective pixel transfer period, and
a dummy pixel transfer clock having a higher clock frequency than that of the effective pixel transfer clock to the CCD during a dummy pixel transfer period following the effective pixel transfer period; and

the dummy pixel transfer period is set equal to a time period required for outputting a number of clocks corresponding to the number of dummy pixels when the clock frequency of the dummy pixel transfer clock is set equal to that of the effective pixel transfer clock.

Here, the drive control unit may output a number of clocks which is greater than or equal to the number of dummy pixels during the dummy pixel transfer period.

The clock frequency of the dummy pixel transfer clock may be any frequency as long as it is higher than that of the effective pixel transfer clock. Preferably, however, it is twice as high as that of the effective pixel transfer clock.

The clock frequency of the dummy pixel transfer clock may be determined based on the time constant obtained from the number of pixels on which a false signal, which is to be produced when signal charges are spilled out due to blooming, may appear.

The image readout apparatus of the present invention is an image readout apparatus in which excitation light is irradiated on a storage phosphor sheet, on which radiation irradiated on a subject from a radiation source and transmitted, through the subject is recorded as a radiation image, to cause stimulated luminescence to be emitted from the storage phosphor sheet, and the stimulated luminescence emitted therefrom is detected by a line sensor to obtain the radiation image, wherein:

the line sensor includes an image sensor having a plurality of effective pixels and a plurality of dummy pixels disposed linearly, and a CCD for shift transferring signal charges from the plurality of effective pixels; and a drive control unit for driving the image sensor to cause the signal charge stored in each of the effective pixels to be shift transferred from the CCD;

the drive control unit includes a clock generator that outputs:
an effective pixel transfer clock to the CCD during an effective pixel transfer period, and
a dummy pixel transfer clock having a higher clock frequency than that of the effective pixel transfer clock to the CCD during a dummy pixel transfer period following the effective pixel transfer period; and

the dummy pixel transfer period is set equal to a time period required for outputting a number of clocks corresponding to the number of dummy pixels when the clock frequency of the dummy pixel transfer clock is set equal to that of the effective pixel transfer clock.

Here, the line sensor may include a plurality of image sensors or a single image sensor.

According to the image sensor drive control unit of the present invention, the dummy pixel transfer clock having a higher clock frequency than that of the effective pixel transfer clock is outputted to the CCD during the dummy pixel transfer period following the effective pixel transfer period, and the dummy pixel transfer period is set to a time period required for outputting a number of clocks corresponding to the number of dummy pixels when the clock frequency of the dummy pixel transfer clock is set equal to that of the effective pixel transfer clock. This allows the number of dummy pixel transfer clocks to be increased without modifying the duration of the line period set in the conventional image sensor, and more residual charges remaining in the image sensor may be discharged. Thus, degradation in the image quality due to blooming may be prevented without requiring a system change for the conventional apparatus, in which the signal processing means, image processing means, and the like are modified.

If the clock frequency of the dummy pixel transfer clock is set twice as high as that of the effective pixel transfer clock, more residual charges may be discharged and the degradation in the image quality due to blooming may be prevented even more satisfactorily.

If the clock frequency of the dummy pixel transfer clock is determined based on the time constant obtained from the number of pixels on which a false signal, which is to be produced when signal charges are spilled out due to blooming, may appear, the residual charges may be removed reliably from the pixels which otherwise may cause degradation in the image quality due to blooming.

### BRIEF DESCRIPTION OF THE DRAWINGS

FIG. 1A is a perspective view of a preferred embodiment of the image readout apparatus of the present invention, illustrating the construction thereof.

FIG. 1B is a cross-sectional view of a preferred embodiment of the image readout apparatus of the present invention, illustrating the construction thereof.

FIG. 2 is a schematic drawing of the line sensor shown in FIG. 1, illustrating an exemplary construction thereof.

FIG. 3 is a schematic drawing of the line sensor shown in FIG. 1, illustrating an exemplary construction thereof.

FIGS. 4A and 4B are schematic drawings of the image sensor, illustrating an exemplary construction thereof.

FIGS. 5A and 5B are schematic drawings for illustrating noise development in a radiation image read out by the image sensor.

FIG. 6A to 6E are graphs illustrating examples of different clocks generated by the drive control unit shown in FIG. 1.

FIGS. 7A to 7E are graphs illustrating examples of different clocks generated by the conventional drive control unit.

### DESCRIPTION OF THE PREFERRED EMBODIMENTS

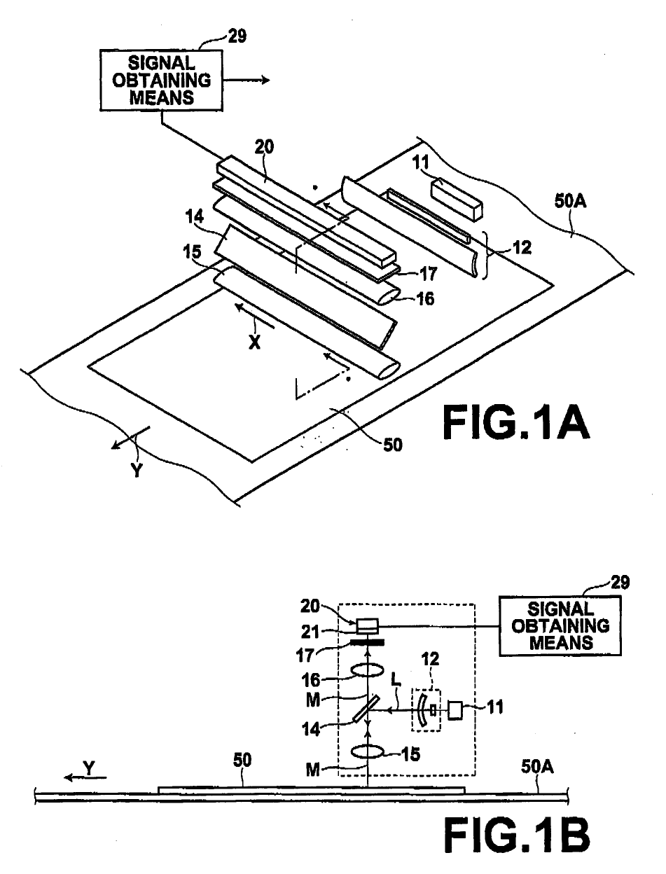

Hereinafter, an embodiment of the image readout apparatus of the present invention will be described with reference to the accompanying drawings. FIG. 1A is a perspective view of the image readout apparatus, and FIG. 1B is a cross-sectional view thereof taken along the line I-I in FIG. 1A.

The image readout apparatus shown in FIGS. 1A and 1B includes a scanning belt 50A for placing a storage phosphor sheet 50 (hereinafter referred to as “sheet”) having radiation image information stored and recorded thereon, and conveying it in the arrow Y direction in FIG. 1; and an excitation light source 11 for emitting a secondary linear excitation light L (hereinafter simply referred to as “excitation light”) in the direction which is substantially parallel to the surface of the storage phosphor sheet 50. The apparatus further includes a line sensor having a plurality of image sensors 22 arranged therein for photoelectrically converting stimulated luminescence M emitted from the storage phosphor sheet 50 when the excitation light L emitted from the excitation light source 11 is irradiated on the storage phosphor sheet 50; and a signal obtaining means 29 for obtaining image signals representing the radiation image information stored and recorded on the storage phosphor sheet 50 by sequentially reading out signals outputted from each of the image sensors 22 of the line sensor 20 in accordance with the movement of the storage phosphor sheet 50.

An optical system 12 constituted by the combination of a collimating lens for condensing the linear excitation light L emitted from the excitation light source 11 and a toric lens for extending the beam only in one direction; a dichroic mirror 14 for reflecting the excitation light L outputted from the optical system 12 toward the surface of the storage phosphor sheet 50; and a gradient index lens array 15 (in which a plurality of gradient index lenses is arranged, which, hereinafter, is referred to as “first gradient index lens array”) for condensing the linear excitation light L reflected by the dichroic mirror 14 on the storage phosphor sheet 50 in a line (with a line width of, for example, 100 μm) extending in the arrow X direction are disposed between the excitation light source 11 and the storage phosphor sheet 50.

The first gradient index lens array 15 collimates the stimulated luminescence M emitted from the storage phosphor sheet 50 according to the radiation image information stored and recorded thereon when the linear excitation light L is condensed thereon, and outputs the collimated luminescence M toward the dichroic mirror 14. The dichroic mirror 14 transmits the stimulated luminescence M emitted from the storage phosphor sheet 50.

Further, a second gradient index lens array 16 for condensing the stimulated luminescence M transmitted through the dichroic mirror 14 on the light receiving surface of each of the image sensors 22, and an excitation light cut filter 17 for transmitting only the stimulated luminescence M by cutting off the excitation light L reflected from the surface of the storage phosphor sheet 50 and contained in the stimulated luminescence M transmitted through the second gradient index lens array 16 are disposed between the dichroic mirror 14 and the line sensor 20.

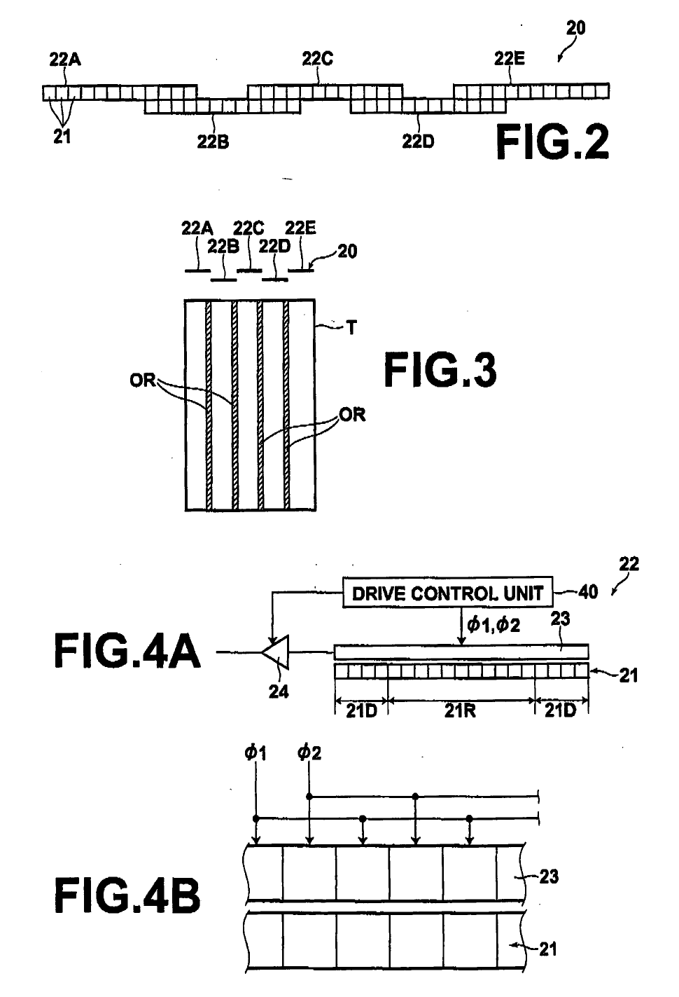

As shown in FIGS. 2 and 3, the line sensor 20 is constituted by a plurality of image sensors 22A to 22E, each having a multitude of pixels 21 disposed linearly in the longitudinal axis direction (X direction in the drawings), arranged in the longitudinal axis direction such that a portion of each image sensor overlaps with a portion of the adjacent image sensor. As for the pixel 21, for example, an amorphous silicon sensor, a CCD sensor, a MOS image sensor, or the like may be used. Here, each of the image sensors 22A to 22E is constituted by a plurality of effective pixels 21R and a plurality of dummy pixels 21D disposed linearly as shown in FIG. 4A, and the signal charge stored in each of the effective pixels 21R is shift transferred from the CCD.

Signal charge readout control is performed by a drive control unit 40. The drive control unit 40 is constituted, for example, by a FPGA (Field Programmable Gate Array), and drives each image sensor 22 using a two-phase drive system as shown in FIG. 4B.

Hereinafter, an exemplary operation of the image readout system will be described. The storage phosphor sheet 50 having radiation image information stored and recorded thereon is placed on the scanning belt 50A, which is moved in the arrow Y direction to move the storage phosphor sheet 50 in the arrow Y direction. In the meantime, the linear excitation light L extending in the arrow X direction is emitted from the excitation light source 11 in the direction which is substantially parallel to the surface of the storage phosphor sheet 50. The excitation light L is condensed on the storage phosphor sheet 50 through the optical system 12, dichroic mirror 14, and first gradient index lens array 15.

The linear excitation light L incident on the storage phosphor sheet 50 excites the storage phosphor in the area of the storage phosphor sheet 50 on which the light is condensed, and also the storage phosphor of the adjacent area by penetrating inside of the storage phosphor sheet from the light condensed area and diffusing to the adjacent area. As a result, the stimulated luminescence M having a light intensity according to the radiation image information stored and recorded on the storage phosphor sheet 50 is emitted from the light condensed area of the storage phosphor sheet 50 and the adjacent area thereof.

The stimulated luminescence M emitted from the storage phosphor sheet 50 is collimated by the first gradient index lens array 15, transmitted through the dichroic mirror 14, and condensed on the light receiving surface of each of the image sensors 22 constituting the line sensor 20 by the second gradient index lens array 16. Here, the excitation light L reflected from the surface of the storage phosphor sheet 50 and contained in the stimulated luminescence M transmitted through the second gradient index lens array is cut off by the excitation light cut filter 17.

The stimulated luminescence M received by each of the image sensors 22 of the line sensor 20 is photoelectrically converted and inputted to the signal obtaining means 29. In the signal obtaining means 29, the signals inputted thereto are converted to digital signals through A/D conversion, and stored with the positional information of the storage phosphor sheet 50 related thereto. In this way, radiation image data P representing the radiation image stored and recorded on the storage phosphor sheet 50 are obtained.

Here, signals obtained by the image sensors 22 of the line sensor 20 at the overlapped region are duplicated. As described in U.S. Patent Application Publication No. 20020028011, a certain number of pixels are overlapped with each other at the boundary section of the image sensors in the overlapped region OR, and the same position is read out by two image sensors independently. Then, the output level of one of the image sensors in the overlapped region is adjusted to the other to implement real-time correction by the signal obtaining means 29. Thus, partial images obtained by the respective image sensors may be aligned smoothly without any problem unless the signals of the overlapping foremost pixels are not affected by the signals of the latter pixels in the image sensor.

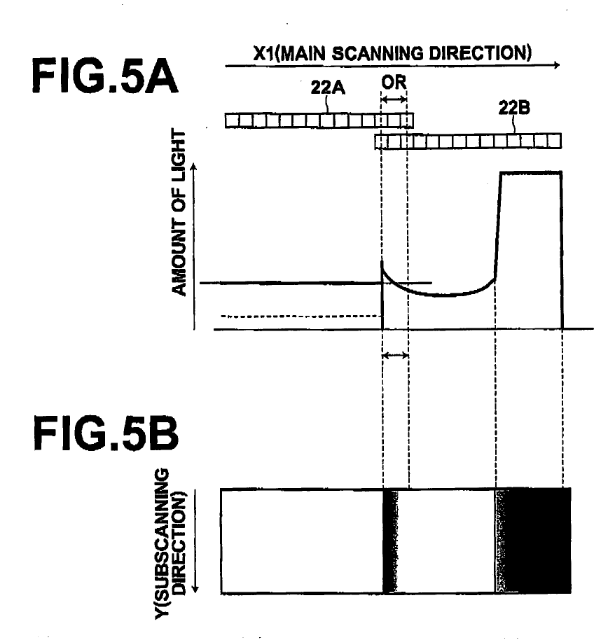

But, when the latter pixels of the image sensor 22B receive radiation that exceeds the capacity of the pixels as shown in FIG. 5A, and if the foremost pixel signals are affected by the latter pixel signals due to, for example, blooming, or the like, a strip-like transverse streak is developed due to difference in the level with the preceding line through level correction as shown in FIG. 5B. Here, it is customary to use a photodiode having a wider light receiving area in the image readout apparatus 1 in order to improve the S/N ratio. Wider light receiving area, however, may result in increased noise due to dark current and increased variation in the charge storage capacity among the pixels.

Thus, it is necessary to increase the charge capacity of the CCD to prevent blooming. One of the methods for increasing the charge capacity of the CCD is to increase the transfer amplitude by deeply forming the potential of the CCD, which is, however, more likely to cause charge traps to be formed adjacent to the surface of the MOS layer Further, where a large amount of charges are passed through a narrow region, more charges are likely to pass through near the surface, causing more charges to be trapped by the charge traps. The trapped charges flow out of the charge traps in each transfer, which causes a false signal, such as tailing or the like, to be produced and contained in the image information. For example, for the general transfer speed of several to several tens of MHz, the false signal overlaps with the image information from the foremost pixel to several tens to several hundreds of pixels. This is not perceivable when the image is produced using a single image sensor due to optical flare. But, when a complete image is produced by aligning partial images read out by a plurality of image sensors, it appears as an image irregularity.

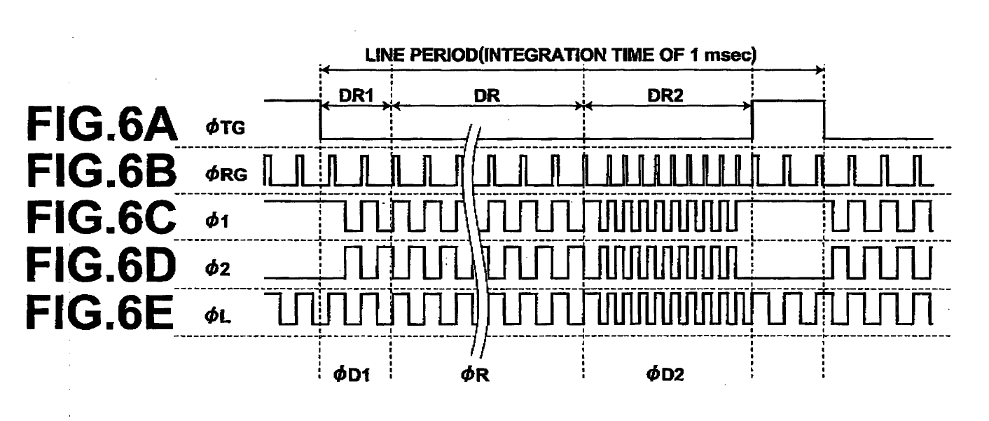

In order to prevent degradation in the image quality due to blooming, the drive control unit 40 drives each of the image sensors 22A to 22E at the timings shown in FIGS. 6A to 6E. The drive control unit 40 outputs a clock ΦTG shown in FIG. 6A for switching on and off the transfer gate of the CCD 23, a reset clock ΦRG shown in FIG. 6B, a CCD driving clock Φ1 shown in FIG. 6C, a CCD driving clock Φ2 shown in FIG. 6D, and a transfer clock ΦL shown in FIG. 6E. The CCD driving clock Φ1, reset clock ΦRG, and transfer clock ΦL are drive controlled such that their rise timings are synchronized.

Here, a single line period is constituted by a first dummy pixel transfer period DR1 for reading out signal charges from the dummy pixels 21D, an effective pixel transfer period DR for reading out signal charges from the effective pixels 21R following the first dummy pixel transfer period DR1, and a second dummy pixel transfer period DR2 for reading out signal charges from the dummy pixels 21D following the effective pixel transfer period DR. The drive control unit 40 includes clock generators that output a first dummy pixel transfer clock ΦD1 during the first dummy pixel transfer period DR1, an effective pixel transfer clock ΦR during the effective pixel transfer period DR, and a second dummy pixel transfer clock ΦD2 during the second dummy pixel transfer period DR2 as the CCD driving clocks Φ1 and Φ2 respectively.

The first dummy pixel transfer clock ΦD1 and the effective pixel transfer clock ΦR have the same clock frequency. The first dummy pixel transfer clock ΦD1 outputs a number of clocks that correspond to the number of dummy pixels 21D during the first dummy pixel transfer period DR1, and the effective pixel transfer clock ΦR outputs a number of clocks that corresponds to the number of effective pixels 21R during the effective pixel transfer period DR. Here, the clock frequency of the effective pixel transfer clock ΦR is set to a transfer frequency required for the image reading.

In the meantime, the second dummy pixel transfer clock ΦD2 has a clock frequency which is higher than that of the effective pixel transfer clock ΦR, and outputs a number of clocks which is greater or equal to the number of dummy pixels 21D during the second dummy pixel transfer period DR2.

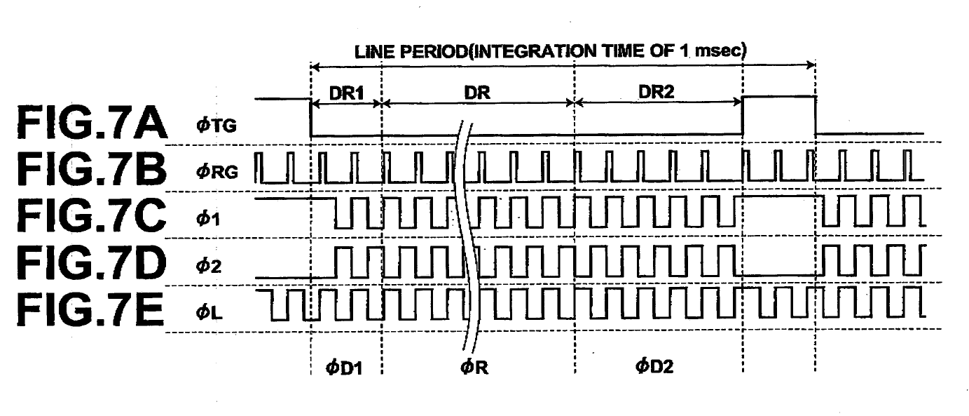

Further, the dummy pixel transfer period DR2 is set equal to a time period required for outputting a number of clocks corresponding to the number of dummy pixels 21D when the clock frequency of the second dummy pixel transfer clock ΦD2 is set equal to that of the effective pixel readout clock as shown in FIG. 7. This allows the number of second dummy pixel transfer clocks ΦD2 to be increased without changing the duration of the second dummy pixel transfer period DR2 of the conventional image sensor, and more residual charges remaining in the image sensors 22A to 22E to be discharged. Thus, degradation in the image quality due to blooming may be prevented without requiring a system change for the conventional apparatus, in which the signal processing means, image processing means, and the like are modified.

In other words, if the number of clocks is increased with the second dummy pixel transfer clock ΦD2 being driven by the clock frequency which is equal to that of the effective pixel transfer clock ΦR as shown in FIG. 7, the second dummy pixel transfer period DR2 is extended and the throughput is degraded. On the other hand, the increase in the clock frequency of the second dummy pixel transfer clock ΦD2 may expedite the discharge of spilled signal charges without impacting on the image quality simply because the second dummy pixel transfer period DR2 is a period for transferring the signal charges of the dummy pixels. In this way, degradation in the image quality due to blooming may be prevented.

If the clock frequency of the second dummy pixel transfer clock ΦD2 is set twice as high as that of the effective pixel transfer clock ΦR, more residual charges may be discharged, and degradation in the image quality due to blooming may be prevented even more satisfactorily.

Here, the clock frequency of the dummy pixel transfer clock may be determined based on the time constant obtained from the number of pixels on which a false signal, which is to be produced when signal charges are spilled out due to blooming, may appear. Then, the clock frequency that may produce a number of clocks corresponding to the number of pixels on which the false signal is actually produced may be set in the second dummy pixel transfer period DR2. This ensures removal of the residual charges from the pixels which otherwise may cause degradation in the image quality due to smearing.

The embodiment of the present invention is not limited to the aforementioned embodiment. For example, FIGS. 2 and 3 show the line sensor 20 using a plurality of image sensors 22A to 22E as an example. But the drive control unit 40 described above may also be applied to the line sensor using a single image sensor.

What is claimed is:

1. A drive control unit for driving an image sensor having a plurality of effective pixels and a plurality of dummy pixels disposed linearly to cause a signal charge stored in each of the effective pixels to be shift transferred from a CCD, wherein:
the drive control unit includes a clock generator that outputs:
an effective pixel transfer clock to the CCD during an effective pixel transfer period, and
a dummy pixel transfer clock having a higher clock frequency than that of the effective pixel transfer clock to the CCD during a dummy pixel transfer period following the effective pixel transfer period; and
the dummy pixel transfer period is set equal to a time period required for outputting a number of clocks corresponding to the number of dummy pixels when the clock frequency of the dummy pixel transfer clock is set equal to that of the effective pixel transfer clock.

2. The image sensor drive control unit according to claim 1, wherein the clock frequency of the dummy pixel transfer clock is set twice as high as that of the effective pixel clock.

3. The image sensor drive control unit according to claim 1, wherein the clock frequency of the dummy pixel transfer clock is determined based on the time constant obtained from the number of pixels on which a false signal, which is to be produced when signal charges are spilled out due to blooming, may appear.

4. An image readout apparatus in which excitation light is irradiated on a storage phosphor sheet, on which radiation irradiated on a subject from a radiation source and transmitted through the subject is recorded as a radiation image, to cause stimulated luminescence to be emitted from the storage phosphor sheet, and the stimulated luminescence emitted therefrom is detected by a line sensor to obtain the radiation image, wherein:
the line sensor includes an image sensor having a plurality of effective pixels and a plurality of dummy pixels disposed linearly, and a CCD for shift transferring signal charges from the plurality of effective pixels; and a drive control unit for driving the image sensor to cause the signal charge stored in each of the effective pixels to be shift transferred from the CCD;
the drive control unit includes a clock generator that outputs:
an effective pixel transfer clock to the CCD during an effective pixel transfer period, and
a dummy pixel transfer clock having a higher clock frequency than that of the effective pixel transfer clock to the CCD during a dummy pixel transfer period following the effective pixel transfer period; and
the dummy pixel transfer period is set equal to a time period required for outputting a number of clocks corresponding to the number of dummy pixels when the clock frequency of the dummy pixel transfer clock is set equal to that of the effective pixel transfer clock.

5. The image readout apparatus according to claim 4, wherein the line sensor comprises a plurality of image sensors.
